(19) United States
(12) Patent Application Publication
(10) Pub. No.: US 2019/0369752 A1
(43) Pub. Date: Dec. 5, 2019

(54) STYLUSES, HEAD-MOUNTED DISPLAY SYSTEMS, AND RELATED METHODS

(71) Applicant: Oculus VR, LLC, Menlo Park, CA (US)

(72) Inventors: John Ikeda, Seattle, WA (US); Robin Michael Miller, Redmond, WA (US); Jason Andrew Higgins, Seattle, WA (US); Khaled Boulos, Seattle, WA (US); Chun Li Chen, Seattle, WA (US); Peter Wesley Bristol, Seattle, WA (US)

(21) Appl. No.: 15/992,757

(22) Filed: May 30, 2018

(51) Int. Cl. G06F 3/0354; G02B 27/01; G06F 3/045; G06F 3/01; G06F 3/0488

(52) U.S. Cl. CPC G06F 3/03545; G02B 27/017; G06F 3/016; G06F 3/017; G06F 3/04883; G06F 3/045

(57) ABSTRACT

A stylus may include an elongated housing, at least one sensor that is configured to detect manipulation of the stylus by a user, and a tracking component that enables the stylus to be tracked in a virtual, augmented, or mixed reality environment. A corresponding head-mounted display system may include a stylus with an elongated housing and a tracking component, a tracking subsystem that is configured to track manipulation of the stylus using the tracking component, and a display subsystem configured to display the manipulation of the stylus within a virtual, augmented, or mixed reality environment. A related method of assembling a stylus including coupling at least one sensor to an elongated housing and coupling a tracking component to the elongated housing.

### BACKGROUND

Virtual reality (VR) systems and augmented reality (AR) systems may enable users to experience an immersive computing, entertainment, or gaming experience. While wearing a head-mounted display (HMD), a user can view portions of a captured scene or an artificially generated scene by orienting his or her head and eyes, just as the user naturally does to view a real-world environment. The user can also interact with and control virtual features that are displayed in some HMDs using a wired or wireless controller. However, it can be difficult to track such controllers with sufficient precision and accuracy to perform certain tasks in a VR/AR environment, such as writing, drawing, pointing, gesturing, etc.

### SUMMARY

As will be described in greater detail below, the present disclosure describes styluses for use in a virtual, augmented, or mixed reality (“VR/AR/MR”) environment and associated HMD systems. In some examples, the styluses include at least one sensor for detecting manipulation of the stylus and a tracking component that enables the stylus to be tracked.

For example, a VR/AR/MR stylus may include an elongated housing that is dimensioned to be grasped by a user's hand, at least one sensor that is configured to detect manipulation of the stylus by the user, and a tracking component that enables the stylus to be tracked in a VR/AR/MR environment. Such a stylus may also include a communication component configured to transmit sensor data generated by the sensor to an HMD system.

In some examples, manipulation of the stylus may include movement of the stylus in a shape resembling a grapheme. Manipulation of the stylus may also include a pressure exerted on a stylus. In this example, the sensor may include a pressure sensor that is configured to detect the pressure exerted on the stylus and generate sensor data based on the same. For example, the sensor may include pressure sensors that are disposed along the elongated housing and configured to detect pressure exerted by at least one finger of the user's hand. Such pressure sensors may include a matrix of pressure sensing electrodes that is wrapped around at least a portion of the elongated housing.

The sensor of the stylus may also include a pressure-sensitive tip that is configured to detect pressure exerted on a tip of the stylus when the stylus interacts with a surface and/or a magnetic field sensor that is configured to detect rotation of a magnetic ball positioned at a tip of the stylus when the stylus interacts with a surface. The stylus may also include a haptic-feedback module that is configured to provide haptic feedback to the user in response to the manipulation.

In one example, the stylus may be configurable between a surface mode, in which the sensor detects manipulation of the stylus as the stylus interacts with a passive surface, and a non-surface mode, in which the sensor detects manipulation of the stylus within space. In addition, the sensor of the stylus may include at least one inertial measurement unit sensor that is disposed within the elongated housing and configured to generate sensor data relating to the manipulation of the stylus.

The manipulation of the stylus may also include a press of at least one mechanical button, a touch of at least a portion of the stylus, a dragging touch across at least a portion of the stylus, a tilting of the stylus, a press of a tip of the stylus against a surface of a real-world object, a movement of the tip of the stylus across the surface of the real-world object, a translation of the stylus in space, and/or a squeezing of the stylus. The tracking component may include at least one of an electrically active component or an electrically passive component.

The present disclosure also details various head-mounted display systems in which the above-described styluses may be used. For example, a head-mounted display system may include a stylus, a tracking subsystem, and a display subsystem. The stylus may include an elongated housing that is dimensioned to be grasped by a user's hand and a tracking component disposed on or within the elongated housing. The tracking subsystem may be configured to track, using at least the tracking component, manipulation of the stylus in a real-world environment. In addition, the display subsystem may be configured to display, based on tracking information received from the tracking subsystem, an image based on the manipulation of the stylus within a VR/AR/MR environment.

In some examples, the tracking subsystem may be configured to track the stylus by (1) capturing images of the stylus in a real-world environment, (2) identifying, within the images, the tracking component of the stylus, and (3) tracking, based on a position of the tracking component within the images, the stylus within the real-world environment. In these examples, the tracking component of the stylus may include at least one infrared light-emitting diode disposed on or within the elongated housing and the tracking subsystem may include an image sensor configured to capture the images of the stylus in the real-world environment.

The stylus may also include at least one sensor that is configured to detect the manipulation of the stylus and a communication component configured to transmit sensor data generated by the sensor to the tracking subsystem. The tracking subsystem may be configured to identify the manipulation of the stylus based on the sensor data received from the communication component, and/or track, using both the tracking component and the sensor data received from the communication component, the stylus within the VR/AR/MR environment. In some examples, the manipulation of the stylus may include movement of the stylus in a shape resembling a grapheme, and the HMD system may also include a processing subsystem configured to identify, based on the movement of the stylus, the grapheme. In these examples, the manipulation of the stylus may also include a pressure exerted on the stylus, and the stylus may include a pressure sensor that is configured to detect the pressure exerted on the stylus and generate sensor data based on the pressure exerted. Such a processing subsystem may be configured to identify the grapheme by identifying, based on the sensor data, a pressure profile that is associated with the grapheme. Pressure exerted on the stylus may include, for example, pressure exerted on a tip of the stylus when the stylus interacts with a surface and/or pressure exerted by at least one of the user's fingers on the elongated housing.

The present disclosure also details various methods of assembling a stylus. In accordance with such methods, at least one sensor may be coupled to an elongated housing that is dimensioned to be grasped by a user's hand. In addition, a tracking component may be coupled to the elongated housing. In this example, the sensor may be configured to detect manipulation of the stylus by the user, and the tracking component may enable the stylus to be tracked in a VR/AR/MR environment.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an HMD system according to some embodiments of the present disclosure.

FIG. 2 is a perspective view of an HMD device according to some embodiments of this disclosure.

FIG. 3 is a block diagram showing example components of a stylus according to some embodiments of this disclosure.

FIG. 4 is a perspective view of a stylus according to some embodiments of the present disclosure.

FIG. 5 is a side view of a stylus according to some embodiments of the present disclosure.

FIG. 6 is a side view of a stylus according to additional embodiments of the present disclosure.

FIG. 7 is a side view of a stylus according to some embodiments of the present disclosure, showing example features and gestures that may be sensed by systems of the present disclosure.

FIG. 8 is a perspective view of a stylus in use, according to some embodiments of the present disclosure.

FIG. 9 is an illustration of a head-mounted display system in use by a user, according to some embodiments of the present disclosure.

FIG. 10 is a flow diagram showing a method of assembling a stylus, according to some embodiments of the present disclosure.

FIG. 11 is a flow diagram showing a method of operating a head-mounted display system, according to some embodiments of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to VR/AR/MR styluses and head-mounted display (HMD) systems that may be used in connection with the same. As will be explained in greater detail below, embodiments of the present disclosure may include a stylus with an elongated housing and a tracking component disposed on or within the elongated housing. The stylus may also have at least one sensor that is configured to detect manipulation of the stylus by the user. A corresponding HMD system may include a tracking subsystem that uses one or both of (1) the tracking component or (2) data from the sensor(s) to track the stylus in a VR/AR/MR environment. As such, HMD systems according to some embodiments of the present disclosure may enable or improve the tracking or performance of styluses or other controllers within a VR/AR/MR environment. For example, embodiments of the disclosure may improve or enable users to perform gestures for interacting with and/or manipulating a virtual feature, the formation of virtual graphemes (e.g., letters, numbers, symbols, etc.), and other accuracy-sensitive tasks.

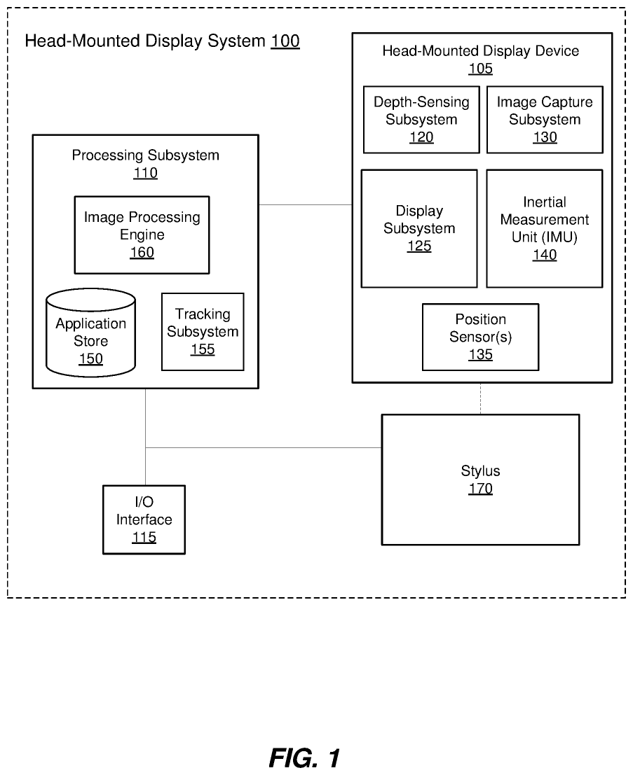

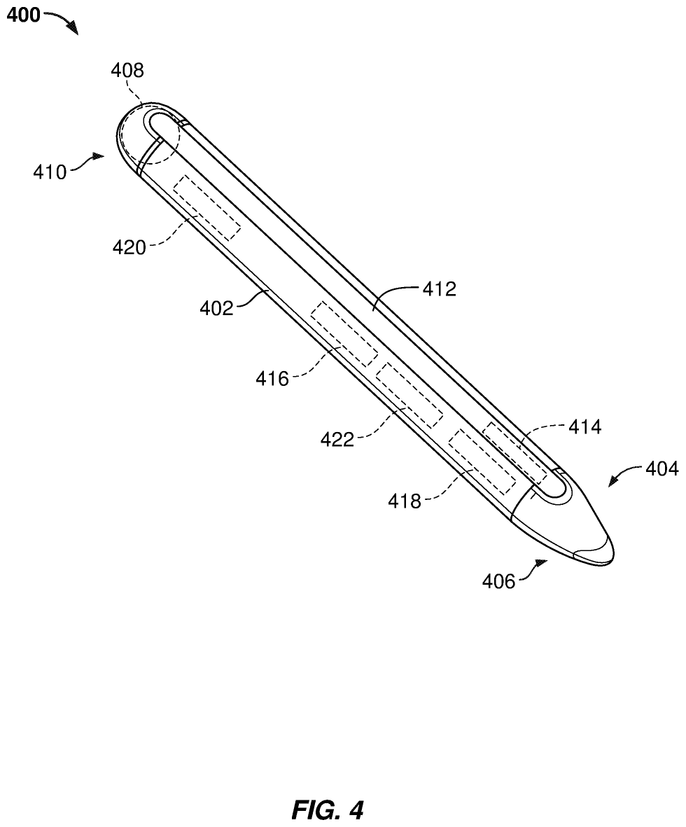

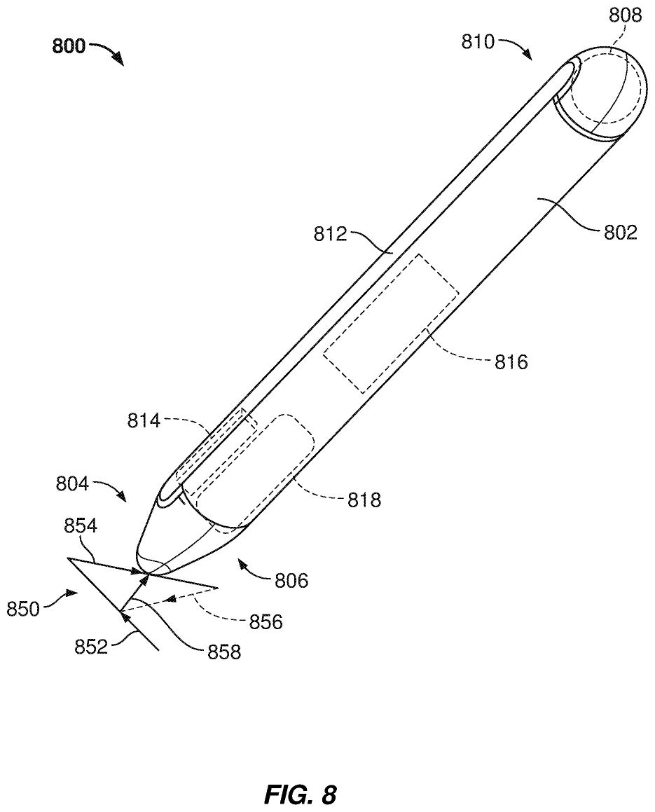

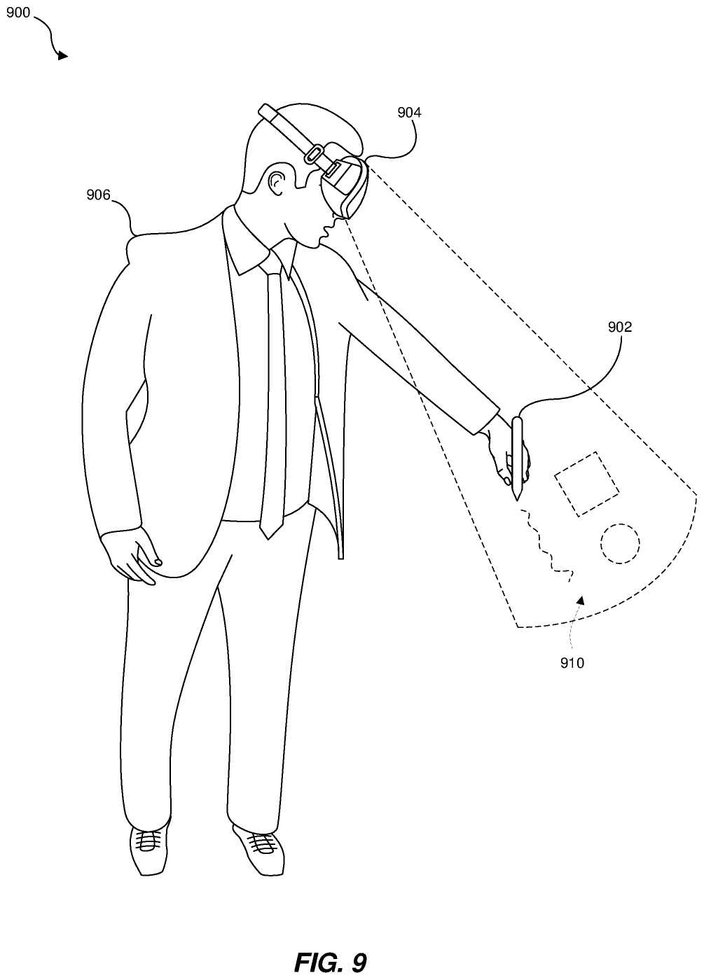

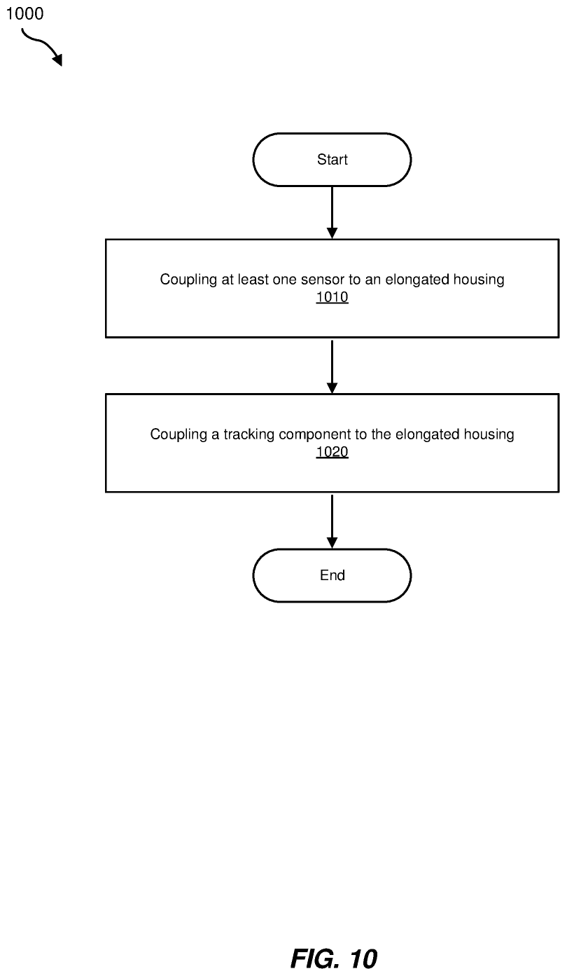

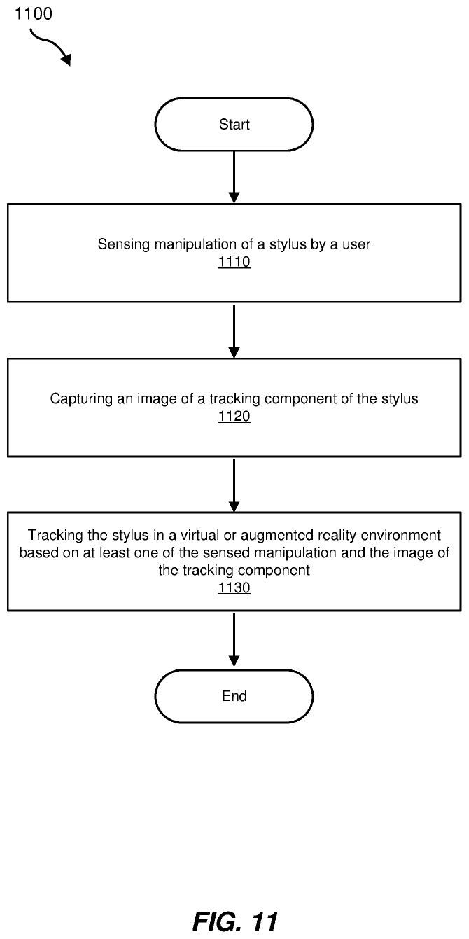

The following will provide, with reference to FIGS. 1-11, detailed descriptions of HMD systems that include a stylus, use and operation of HMD systems and corresponding styluses, and methods of assembling styluses. FIGS. 1-3 provide an overview of such HMD systems. FIGS. 4-7 illustrate various views of styluses, including example features and subsystems. FIGS. 8 and 9 respectively illustrate a stylus and an HMD system in use. FIG. 10 is a flow diagram of a method of assembling a stylus. FIG. 11 is a flow diagram of a method of using an HMD system to track a stylus in a VR/AR/MR environment.

FIG. 1 is a block diagram of an HMD system 100 according to some embodiments of the present disclosure. In some examples, the HMD system 100 may be configured to present images (e.g., captured scenes, artificially-generated scenes or features, or a combination thereof) to a user. For example, the HMD system 100 may operate in a virtual reality (VR) system environment, an augmented reality (AR) system environment, a mixed reality (MR) system environment, or some combination thereof (referred to generally as a “VR/AR/MR environment,” including any single system or combination of VR, AR, and/or MR systems). As illustrated in FIG. 1, the HMD system 100 may include an HMD device 105, a processing subsystem 110, an input/output (I/O) interface 115, and a stylus 170. The HMD device 105 may communicate with the processing subsystem 110 and I/O interface 115, or one or both of the processing subsystem 110 or I/O interface 115 may be included as an integral part of the HMD device 105. In some embodiments, the HMD device 105 may completely obstruct the user's view of the real-world environment. In other embodiments, the HMD device 105 may only partially obstruct the user's view of the real-world environment and/or may obstruct the user's view depending on content being displayed in a display of the HMD device 105.

The HMD device 105 may include a depth-sensing subsystem 120, a display subsystem 125, an image capture subsystem 130, at least one position sensor 135, and an inertial measurement unit (IMU) 140. Other embodiments of the HMD device 105 may include additional or alternative subsystems and features, such as an eye-tracking or gaze-estimation system configured to track the eyes of a user of the HMD device 105. An optional adjustable optical lens assembly may be included and configured to adjust the focus of one or more images displayed on the display subsystem 125 and/or of a view of the real-world environment in front of the user. This adjustable optical lens assembly may, for example, adjust focus based on eye-tracking or gaze-estimation information. Some embodiments of the HMD device 105 may include different or additional components than those described in conjunction with the example block diagram of FIG. 1.

The depth-sensing subsystem 120 may capture data describing depth information characterizing a local real-world area or environment near the HMD device 105 and/or characterizing a position, velocity, or position of the depth-sensing subsystem 120 (and thereby of the HMD device 105) within the local area. The depth-sensing subsystem 120 may compute depth and location information using collected data (e.g., based on captured light according to one or more computer-vision schemes or algorithms, by processing a portion of a structured light pattern (e.g., a projected grid of IR light), by time-of-flight (ToF) imaging, simultaneous localization and mapping (SLAM), etc.), or the depth-sensing subsystem 120 can transmit this data to another device such as an external implementation of the processing subsystem 110 that can determine the depth information using the data from the depth-sensing subsystem 120.

The display subsystem 125 may include an electronic display for rendering two-dimensional or three-dimensional images to the user in accordance with data received from the processing subsystem 110. The display subsystem 125 may, in some examples, include additional components for rendering and/or displaying images, such as a graphics processing unit (GPU), one or more lenses, an eye-tracking element, etc. The display subsystem 125 may include a single electronic display or multiple electronic displays (e.g., a display for each eye of the user). Examples of the display subsystem 125 may include a liquid crystal display (LCD), an organic light-emitting diode (OLED) display, an inorganic light-emitting diode (ILED) display, an active-matrix organic light-emitting diode (AMOLED) display, a transparent organic light-emitting diode (TOLED) display, another suitable display, or some combination thereof. The display subsystem 125 may be opaque such that the user cannot see the local environment through the display subsystem 125 (e.g., for VR or MR applications) or may be at least partially transparent to visible light such that the user can see the local environment while using the display subsystem 125 (e.g., for AR or MR applications).

The image capture subsystem 130 may include one or more optical image sensors or cameras for capturing and collecting image data from a local environment. In some embodiments, the sensors included in the image capture subsystem 130 may provide stereoscopic views of the local environment that may be used by the processing subsystem 110 to generate image data that characterizes the local environment and/or a position and orientation of the HMD device 105 and stylus 170 within the local environment. For example, the image capture subsystem 130 may include simultaneous localization and mapping (SLAM) cameras or other cameras that include a wide-angle lens system for capturing a wider field-of-view than may be captured by the eyes of the user. In some embodiments, the image capture subsystem 130 may include one or more IR sensors, such as for capturing an image of an IR tracking component of the stylus 170 to provide data for tracking the stylus 170. The image capture subsystem 130 may provide pass-through views of the real-world environment that are displayed to the user via the display subsystem 125.

The IMU 140 may, in some examples, represent an electronic subsystem that generates data indicating a position (i.e., location, elevation, orientation, direction of movement, speed of movement, translation, and/or rotation) of the HMD device 105 based on measurement signals received from one or more of the position sensors 135 and from depth information received from the depth-sensing subsystem 120 and/or the image capture subsystem 130. For example, a position sensor 135 may generate one or more measurement signals in response to motion of the HMD device 105. Examples of position sensors 135 include, without limitation, one or more accelerometers, one or more gyroscopes, one or more magnetometers, any other suitable type of sensor that detects motion, a type of sensor used for error correction of the IMU 140, or some combination thereof. The position sensors 135 may be located external to the IMU 140, internal to the IMU 140, or some combination thereof.

Based on the one or more measurement signals from one or more position sensors 135, the IMU 140 may generate data indicating an estimated current position of the HMD device 105 relative to an initial position of the HMD device 105. For example, the position sensors 135 may include multiple accelerometers to measure translational motion (forward/back, up/down, left/right) and multiple gyroscopes to measure rotational motion (e.g., pitch, yaw, roll). As described herein, the image capture subsystem 130 and/or the depth-sensing subsystem 120 may generate data indicating an estimated current position and/or orientation of the HMD device 105 relative to the real-world environment in which the HMD device 105 is used.

The processing subsystem 110, whether as a part of the HMD device 105 or as a standalone system in communication with the HMD device 105, may include an application store 150, a tracking subsystem 155, and an image processing engine 160, for example. In some embodiments, the processing subsystem 110 may be configured to process images (e.g., a visible image, data associated with a captured image, etc.) from the image capture subsystem 130, such as to remove distortion caused by the lens system of the image capture subsystem 130 and/or by a separation distance between two image sensors that is noticeably larger than or noticeably less than an average separation distance between users' eyes. For example, when the image capture subsystem 130 is, or is part of, a SLAM camera system, direct images from the image capture subsystem 130 may appear distorted to a user if shown in an uncorrected format. Image correction or compensation may be performed by the processing subsystem 110 to correct and present the images to the user with a more natural appearance, so that it appears to the user as if the user is looking through the display subsystem 125 of the HMD device 105. In some embodiments, the image capture subsystem 130 may include one or more image sensors having lenses adapted (e.g., in terms of field-of-view, separation distance, etc.) to provide pass-through views of the local environment. The image capture subsystem 130 may be configured to capture color images or monochromatic images.

The I/O interface 115 may represent a subsystem or device that allows a user to send action requests and receive responses from the processing subsystem 110, the HMD device 105, and/or the stylus 170. An action request may, in some examples, represent a request to perform a particular action. For example, an action request may be an instruction to start or end capture of image or video data, an instruction to perform a particular action within an application, or to select a mode of operation (e.g., a pass-through mode for displaying an image of the surrounding real-world environment, a surface mode for interacting the stylus 170 with a physical surface in the real-world environment, a non-surface mode for performing actions with the stylus 170 in an open space, etc., as explained in greater detail below). The I/O interface 115 may include one or more input devices or may enable communication with one or more input devices (e.g., wired or wireless communication). Exemplary input devices may include a keyboard, a mouse, a hand-held controller, the stylus 170, a button or knob on the HMD device 105, a microphone, or any other suitable device for receiving action requests and communicating the action requests to the processing subsystem 110.

An action request received by the I/O interface 115 may be communicated to the processing subsystem 110, which may perform an action corresponding to the action request. In some embodiments, the stylus 170 includes a motion sensor that captures inertial data indicating an estimated position (e.g., location and/or orientation) of the stylus 170 relative to an initial position. In some embodiments, the I/O interface 115 and/or the stylus 170 may provide haptic feedback to the user in accordance with instructions received from the processing subsystem 110 and/or the HMD device 105. For example, haptic feedback may be provided when an action request is received or the processing subsystem 110 communicates instructions to the I/O interface 115 causing the I/O interface 115 to generate or direct generation of haptic feedback when the processing subsystem 110 performs an action.

The processing subsystem 110 may include one or more processing devices or physical processors for providing content to the HMD device 105 in accordance with information received from one or more of: the depth-sensing subsystem 120, the image capture subsystem 130, the I/O interface 115, and the stylus 170. In the example shown in FIG. 1, the processing subsystem 110 includes the image processing engine 160, the application store 150, and the tracking subsystem 155. Some embodiments of the processing subsystem 110 may have different modules or components than those described in conjunction with FIG. 1. Similarly, the functions further described below may be distributed among the components of the HMD system 100 in a different manner than described in conjunction with FIG. 1.

The application store 150 may store one or more applications for execution by the processing subsystem 110. An application may, in some examples, represent a group of instructions, that when executed by a processor, generates content for presentation to the user. Content generated by an application may be generated in response to inputs received from the user via movement of the HMD device 105 or the stylus 170. Examples of such applications include, without limitation, gaming applications, document generation applications, conferencing applications, video playback applications, or other suitable applications.

The tracking subsystem 155 may calibrate the HMD system 100 using one or more calibration parameters and may adjust one or more calibration parameters to reduce error in determination of the position of the HMD device 105 and/or the stylus 170. For example, the tracking subsystem 155 may communicate a calibration parameter to the depth-sensing subsystem 120 to adjust the focus of the depth-sensing subsystem 120 to more accurately determine positions of structured light elements captured by the depth-sensing subsystem 120. Calibration performed by the tracking subsystem 155 may also account for information received from the IMU 140 in the HMD device 105 and/or another motion sensor included in the stylus 170. Additionally, if tracking of the HMD device 105 is lost (e.g., the depth-sensing subsystem 120 loses line of sight of at least a threshold number of structured light elements), the tracking subsystem 155 may recalibrate some or all of the HMD system 100.

The tracking subsystem 155 may include a processing unit for tracking movements of the HMD device 105 and/or of the stylus 170 using information from the depth-sensing subsystem 120, the image capture subsystem 130, the position sensor(s) 135, the IMU 140, a motion sensor of the stylus 170, or some combination thereof. For example, the tracking subsystem 155 may determine a position of a reference point of the HMD device 105 and/or of the stylus 170 in a mapping of the real-world environment based on information collected with the HMD device 105. Additionally, in some embodiments, the tracking subsystem 155 may use portions of data indicating a position and/or orientation of the HMD device 105 and/or stylus 170 from the IMU 140 to predict a future position and/or orientation of the HMD device 105 and/or the stylus 170. The tracking subsystem 155 may also provide the estimated or predicted future position of the HMD device 105 or the I/O interface 115 to the image processing engine 160.

In some embodiments, the tracking subsystem 155 may track other features that can be observed by the depth-sensing subsystem 120, the image capture subsystem 130, and/or by another system. For example, the tracking subsystem 155 may track one or both of the user's hands so that the location of the user's hands within the real-world environment may be known and utilized. For example, the tracking subsystem 155 may receive and process image data in order to determine a pointing direction of a finger of one of the user's hands. The tracking subsystem 155 may also receive information from one or more eye-tracking cameras included in some embodiments of the HMD device 105 to tracking the user's gaze.

The image processing engine 160 may generate a three-dimensional mapping of the area surrounding some or all of the HMD device 105 (i.e., the “local area” or “real-world” environment) based on information received from the HMD device 105. In some embodiments, the image processing engine 160 may determine depth information for the three-dimensional mapping of the local area based on information received from the depth-sensing subsystem 120 that is relevant for techniques used in computing depth. The engine 160 may calculate depth information using one or more techniques in computing depth from structured light (e.g., a projected grid of IR light). In various embodiments, the engine 160 may use the depth information to, e.g., update a model of the local area and generate content based in part on the updated model.

The engine 160 may also execute applications within the HMD system 100 and receive position information, acceleration information, velocity information, predicted future positions, or some combination thereof, of the HMD device 105 and/or stylus 170 from the tracking subsystem 155. Based on the received information, the engine 160 may determine content to provide to the HMD device 105 for presentation to the user. For example, if the received information indicates that the user has looked to the left, the engine 160 may generate content for the HMD device 105 that corresponds to the user's movement in a virtual environment or in an environment augmenting the local area with additional content. Additionally, the engine 160 may perform an action within an application executing on the processing subsystem 110 in response to an action request received from the I/O interface 115 and/or the stylus 170 and provide feedback to the user that the action was performed. The provided feedback may include visual or audible feedback via the HMD device 105 or haptic feedback via the stylus 170, for example.

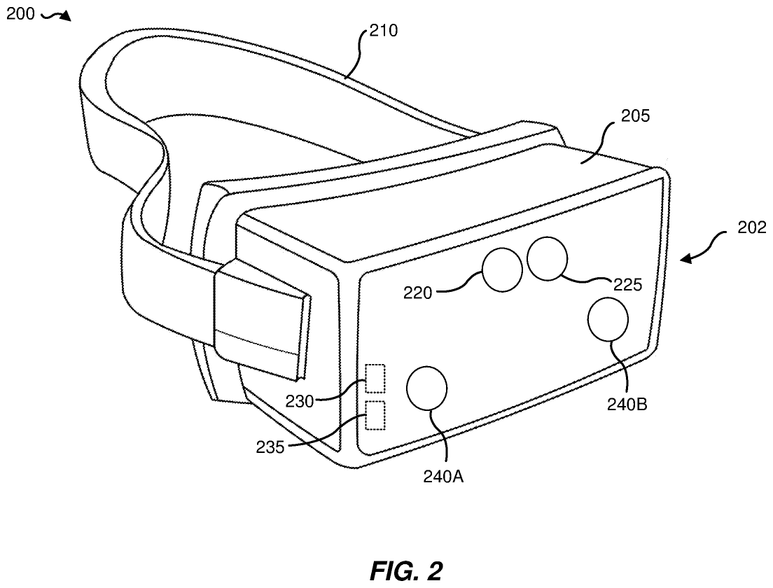

The HMD device 105 may present a variety of content to a user, including virtual views of an artificially rendered virtual-world environment and/or augmented views of a physical, real-world environment, augmented with computer-generated elements (e.g., two-dimensional (2D) or three-dimensional (3D) images, 2D or 3D video, sound, etc.). In some embodiments, the presented content includes audio that is presented via an internal or external device (e.g., speakers and/or headphones) that receives audio information from the HMD device 105, the processing subsystem 110, or both, and presents audio data based on the audio information. In some embodiments, such speakers and/or headphones may be integrated into or releasably coupled or attached to the HMD device 105. The HMD device 105 may also include one or more bodies, which may be rigidly or non-rigidly coupled together. A rigid coupling between rigid bodies may cause the coupled rigid bodies to act as a single rigid entity. In contrast, a non-rigid coupling between rigid bodies may allow the rigid bodies to move relative to each other. An embodiment of the HMD device 105 is the HMD device 200 shown in FIG. 2 and described in further detail below.

FIG. 2 is a perspective view of an example HMD device 200, such as the HMD device 105 illustrated in FIG. 1. The HMD device 200 may be part of, e.g., a VR system, an AR system, an MR system, or some combination thereof. In embodiments that describe an AR system and/or an MR system, portions of a front side 202 of the HMD device 200 may be at least partially transparent to visible light (i.e., light having a wavelength of about 380 nm to about 750 nm). More specifically, portions of the HMD device 200 that are between the front side 202 of the HMD device 200 and an eye of the user may be at least partially transparent (e.g., a partially transparent electronic display of the display subsystem 125 of FIG. 1). In other embodiments, the front side 202 may be opaque to visible light, preventing the user from a direct view of the real-world environment. The HMD device 200 may include a front rigid body 205 housing the display subsystem 125 (FIG. 1) and other components and a user attachment system such as a band 210 that secures the HMD device 200 to a user's head.

In some embodiments, the HMD device 200 may include an imaging subsystem and a depth-sensing subsystem. For example, the HMD device 200 may include an imaging aperture 220 and an illumination aperture 225. An illumination source included in the depth-sensing subsystem 120 (FIG. 1) may emit light (e.g., structured IR light) through the illumination aperture 225. An imaging device of the depth-sensing subsystem 120 (FIG. 1) may capture light from the illumination source that is reflected or backscattered from the local area through the imaging aperture 220. Embodiments of the HMD device 200 may further include cameras 240A and 240B that are components of the image capture subsystem 130 of FIG. 1. The cameras 240A and 240B may be separated from each other by a distance that is the same as or different than the average separation distance between the pupils of users' eyes.

The front rigid body 205 may include or support one or more electronic display elements, one or more integrated eye-tracking systems, an IMU 230, and one or more position sensors 235. The IMU 230 may represent an electronic device that generates fast calibration data based on measurement signals received from one or more of the position sensors 235. The position sensor 235 may generate one or more measurement signals in response to motion of the HMD device 200.

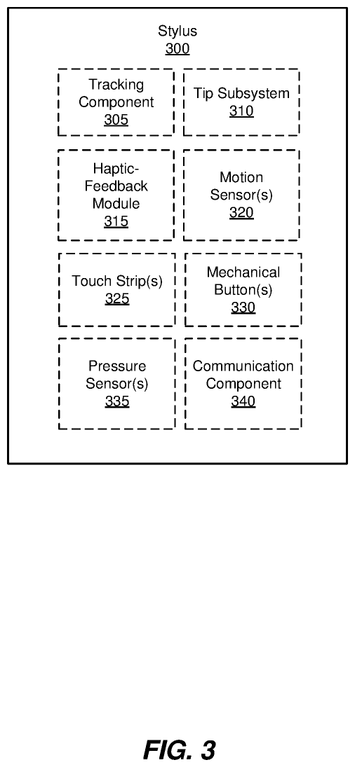

FIG. 3 is a block diagram of a stylus 300 that may be used in HMD systems, such as the HMD system 100 described above with reference to FIG. 1 and/or the HMD device 200 described above with reference to FIG. 2. The stylus 300 may include a variety of subsystems and components designed to facilitate and/or track manipulation, position, and use of the stylus 300. In some examples, “manipulate” or “manipulation” may generally refer to any interaction with the stylus 300, including moving, rotating, tilting, pressing a button, touching a touch sensor, pressing against a surface of a physical object, squeezing, or shaking, etc. Example subsystems and components are illustrated in FIG. 3, although embodiments of a stylus 300 according to this disclosure may include only a subset of the features described herein, or may include additional subsystems and components.

As illustrated in FIG. 3, in some embodiments, the stylus 300 may include a tracking component 305, a tip subsystem 310, a haptic-feedback module 315, at least one motion sensor 320, at least one touch strip 325, at least one mechanical button 330, at least one pressure sensor 335, and a communication component 340.

The tracking component 305 may facilitate tracking (e.g., identification of position and/or orientation) of the stylus 300 in a VR/AR/MR environment. In some examples, the tracking component 305 may represent or include a light source (e.g., a single light-emitting diode (“LED”) or group of LEDs that emits infrared or visible light), a light-reflective element for reflecting visible or infrared light, a magnetic field generator or sensor, or a physical feature with a known shape and orientation, etc. The tracking component 305 may be electrically active (e.g., including a power source for operation) or passive (e.g., not including a power source for operation). As described above, an HMD device (such as the HMD devices 105 or 200 of FIGS. 1 and 2, respectively) may include an image capture subsystem configured to capture images of the stylus in a real-world environment. Image data from the image capture subsystem may be processed by, for example, the image processing engine 160 or tracking subsystem 155 of the processing subsystem 110 (FIG. 1) to identify the tracking component 305 of the stylus 300 in captured images, including an estimation of the position and orientation of the tracking component 305 relative to the HMD device. This information can be used to perform actions within the VR/AR/MR environment, such as to manipulate virtual images generated by the system, to create virtual images, to locate objects in 2D or 3D space, etc.

The tip subsystem 310 may include components located at a tip end portion of the stylus 300. In some applications, a user may use the stylus 300 to draw or write within a VR/AR/MR environment, to point to a real-world or virtual object, to select a real-world or virtual object, to move a real-world or virtual object, to manipulate a virtual object, etc. In some examples, the tip subsystem 310 may be used to facilitate such actions by sensing manipulation of the tip, including sensing pressure on the tip (imparted, for example, by a user's hand or an object), sensing motion of the tip in space, sensing that the tip has been dragged across a surface, sensing the orientation and/or position of the tip, etc. The tip subsystem 310 may include a variety of components or features to facilitate or accomplish such tasks. By way of example, the tip subsystem 310 may include a pressure sensor, a touch sensor, a magnetic field sensor, a rotatable ball with a rotation sensor (e.g., at least one physical roller abutting the rotatable ball, a magnetic field sensor, etc.), a proximity sensor, a thermal sensor, or an ultrasonic emitter and sensor.

The haptic-feedback module 315 may, in some embodiments, be used to provide haptic feedback to the user through the stylus 300 in response to certain actions by the user or as instructed by the processing subsystem to provide an indication to the user. For example, the haptic-feedback module 315 may include a vibrator mechanism to provide constant, intermittent, or patterned vibrations to indicate that a user has successfully performed an action, such as placing the stylus 300 into a particular mode, interacting with a virtual object, starting a virtual drawing or writing operation, positioning the stylus 300 out of a field of view of the HMD device, etc. Different applications may use the haptic-feedback module 315 to provide various indications to the user.

The motion sensor(s) 320 may include an IMU or other device for sensing a position, an orientation, and/or movements of the stylus 300 within a real-world or VR/AR/MR environment. By way of example and not limitation, the motion sensor(s) 320 may include an accelerometer, a gyroscope, a rotation sensor, a magnetometer, an electromagnetic tracking system, etc. Data from the motion sensor(s) 320 may be processed by the processing subsystem 110 of the HMD system 100 (FIG. 1), for example, to determine how and where the stylus 300 moves within the real-world environment, to perform actions such as displaying the location of the stylus 300 within a VR/AR/MR environment, manipulation of virtual objects, displaying a virtual drawing or writing, etc.

The touch strip(s) 325 may be an input element on the stylus 300 for sensing touch by the user or by a physical object. For example, the touch strip(s) 325 may include a capacitive touch element, a resistive touch element, or other touch sensor to enable the user to interact with and provide input (e.g., selections, gestures, etc.) to the stylus 300. Data from the touch strip(s) 325 may be processed by the processing subsystem 110 of the HMD system 100 (FIG. 1), for example, to determine actions desired by the user in the VR/AR/MR environment.

The stylus 300 may include at least one mechanical button 330 as another input element for the user to manipulate (e.g., interact with) the stylus 300. The user may press the mechanical button 330 to perform various actions. By way of example and not limitation, the mechanical button 330 may be used to make a selection of a virtual object or command, to change a mode of operation of the stylus 300 (e.g., between a surface mode for interacting with a physical surface in the real world and a non-surface mode for performing actions with the stylus 300 in an open space, between on and off modes, between passive and active modes, etc.), or to manipulate (e.g., virtually grab, move, etc.) a virtual object.

The pressure sensor(s) 335 may obtain data representative of pressure on the stylus 300. The pressure sensor(s) 335 may include, for example, a solitary pressure sensor, a matrix of pressure sensing electrodes, a pressure sensor configured to detect pressure on a tip of the stylus 300, a pressure sensor configured to detect pressure on a back end portion of the stylus 300, a pressure sensor or matrix of pressure sensors associated with (e.g., positioned beneath) the touch strip(s) 325, a pressure sensor associated with (e.g., positioned beneath) the mechanical button(s) 330, etc. The pressure sensor(s) 335 may provide the sensed data representative of pressure to the processing subsystem 110 of the HMD system 100 (FIG. 1) to be processed, and the processing subsystem 110 may generate an action or reaction based on the sensor data in the VR/AR/MR environment.

The communication component 340 may be configured to communicate data from the various other components of the stylus 300 to the I/O interface 115, the processing subsystem 110, and/or the HMD device 105 (FIG. 1). The communication may occur wirelessly (e.g., via WI-FI, radio, BLUETOOTH, near-field communications (NFC), etc.) or via a wired connection. By way of example, the communication component 340 may be or include a printed circuit board (PCB) and/or a chip that is configured to communicate wirelessly, such as a WI-FI module, a BLUETOOTH module, an NFC module, etc.

FIGS. 4-8 illustrate various views and embodiments of styluses for use in a VR/AR/MR environment, such as in connection with the HMD systems and devices described above. Features and elements described below in relation to each of FIGS. 4-8 may be interchanged and incorporated in different embodiments of the present disclosure.

FIG. 4 shows a perspective view of a stylus 400 according to an embodiment of this disclosure. The stylus 400 includes an elongated housing 402 that is dimensioned (e.g., sized and shaped) to be grasped by a user's hand. A tip subsystem 404 may positioned at a tip end portion 406 of the stylus 400, and a tracking component 408 may be positioned at a back end portion 410 of the stylus, for example. Example tip subsystems and tracking components suitable for use with the stylus 400 are described above with reference to FIG. 3.

In some embodiments, the tracking component 408 may be positioned at any location along the elongated housing 402 of the stylus 400, including at multiple locations (e.g., at the back end portion 410, at the tip end portion 406, at an intermediate location between the back end portion 410 and the tip end portion 406, any combination thereof, etc.). For example, the tracking component 408 may be positioned in one or more locations where at least a portion of the tracking component 408 can be viewed by an image sensor of an HMD device or system, to facilitate and/or enable tracking of the stylus 400 within a real-world environment, for tracking within a VR/AR/MR environment. Multiple tracking components 408 may be employed to provide improved (e.g., redundant) tracking of the stylus 400, such as to enable views of at least one tracking component 408 while another is fully or partially covered by the user's hand.

A touch strip 412 may be positioned along an external surface of the elongated housing 402. The touch strip 412 may include a touch-sensitive surface including, for example, a capacitive touch element, a resistive touch element, or other touch sensor to enable the user to interact with and provide input (e.g., selections, gestures, etc.) to the stylus 400 and ultimately to an associated HMD system. As shown in FIG. 4, the touch strip 412 may extend along a length of the elongated housing 402 from the tip end portion 406 to the back end portion 410 and along one side of the stylus 400. However, in other embodiments, the touch strip 412 may have a different configuration, such as only along a portion of one side of the stylus (e.g., proximate the tip end portion 406 and/or proximate the back end portion 410), along more than one side of the stylus 400, wrapping around a full or partial circumference of the elongated housing 402, or in multiple distinct segments.

At least one mechanical button 414 may be positioned under the touch strip 412, as shown in FIG. 4, or in other locations on or in the elongated housing 402 (e.g., at or near the tip end portion 406, at or near the back end portion 410, in an intermediate location between the tip end portion 406 and the back end portion 410, on a side of the elongated housing 402 adjacent to the touch strip 412, on a side of the elongated housing 402 opposite the touch strip 412, etc.). The mechanical button(s) 414 may provide another option for the user to manipulate the stylus 400 and interact with the associated HMD system, such as to indicate a selection of a virtual or real-world object in a VR/AR/MR environment, to change modes of operation of the stylus 400, to manipulate a virtual object, to capture and save an image of the real-world environment, etc.

A motion sensor 416 disposed within the elongated housing 402 may record data relevant to the position, orientation, and/or movement of the stylus 400. Example motion sensors suitable for use in the stylus 400 are described above with reference to FIG. 3.

At least one pressure sensor 418 may be disposed on or in the elongated housing 402, which may be configured to detect a pressure exerted on the stylus 400 such as from a hand or finger of a user, from an object in the real-world environment, and so forth. The pressure sensor(s) 418 may be positioned in a location along the elongated housing to facilitate interaction with the pressure sensor(s) 418. For example, the pressure sensor(s) 418 may be located proximate the tip end portion 406 in a location that an average user might grip the stylus 400 during use, such as during a virtual writing, drawing, or object selection action. The pressure sensor(s) 418 may additionally or alternatively be positioned under the touch strip 412, to enable the sensors of the stylus 400 to detect simultaneous touch and pressure inputs from the user. The pressure sensor(s) 418 may also be positioned in association with the tip subsystem 404 to detect pressure on the tip end portion 406 during use of the stylus 400 in a surface mode configured for interaction with (e.g., virtual writing or drawing on) a physical surface in the real-world environment. In some examples, the physical surface may be a passive surface with no stylus-tracking capabilities. The pressure sensor(s) 418 may additionally or alternatively be positioned at the back end portion 410 of the stylus 400 to detect additional pressure exerted, such as for a virtual erase action, virtual or real-world object selection, etc. Example pressure sensor(s) that are suitable for use in the stylus 400 are described above with reference to FIG. 3.

The stylus 400 may also include a communication component 420 that is configured to transmit sensor data generated by one or more of the tip subsystem 404, tracking component 408, touch strip 412, mechanical button(s) 414, motion sensor 416, and pressure sensor(s) 418 to the associated HMD system (e.g., to a processing subsystem, an HMD display, or an I/O interface, etc.).

A haptic-feedback module 422 may be disposed within the elongated housing 402 to provide haptic feedback to the user for various reasons, such as to indicate that a command has been accepted, more information is needed, a virtual object has been interacted with, an incoming message has been received, etc. Example haptic-feedback modules suitable for use with the stylus 400 are described above with reference to FIG. 3.

Although FIG. 4 has been described with reference to certain components and features of the stylus 400 as illustrated, the stylus 400 according to other embodiments may include additional or alternative components and features as described in this disclosure, or as may be implemented for a desired application by one skilled in the art. Additionally, the components and features depicted in FIG. 4 may, in some embodiments, be positioned in different locations on or in the stylus 400 as may be convenient for design, expected use, weight distribution, or space considerations, for example.

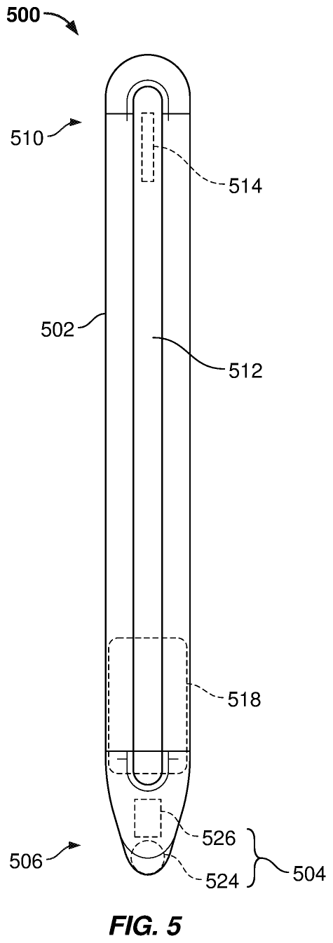

Referring to FIG. 5, a side view of another embodiment of a stylus 500 is shown. The stylus 500 may be similar to the stylus 400 described above with reference to FIG. 4, and may include other elements described herein that are not depicted in FIG. 5. The stylus 500 may include an elongated housing 502 dimensioned to be grasped by a user's hand, a tip subsystem 504 at a tip end portion 506, a back end portion 510 at an opposite longitudinal end of the stylus 500 from the tip end portion 506, a touch strip 512 along a portion of a length of the stylus 500, and a mechanical button 514. However, FIG. 5 illustrates the mechanical button 514 proximate the back end portion 510 of the stylus 500.

FIG. 5 shows a pressure sensor in the form of a pressure sensor matrix 518 near the tip end portion 506, wrapped at least partially around a circumference of the elongated housing 502. In some embodiments, the pressure sensor matrix 518 may be positioned along an entire circumference of the elongated housing 502. The position of the pressure sensor matrix 518 proximate the tip end portion 506 may facilitate or enable the detection of pressure applied to the stylus 500 by at least one finger of a user, such as during a writing, drawing, or other operation. The pressure sensor matrix 518 may include multiple pressure-sensing electrodes arranged across its area, such that pressure may be detected from one or more fingers when the stylus 500 is grasped by a user at a variety of different rotational orientations and axial locations.

In some embodiments, the pressure sensor matrix 518 may be configured to detect pressure(s) exerted on the stylus 500 during a writing or drawing operation, for example, to provide data for identifying a pressure profile associated with certain user actions, such as writing graphemes. In some examples, “grapheme” may refer to a letter, number, punctuation mark, pictograph, or other symbol. As a user writes a grapheme, the fingers and hand of the user may move in a way that results in the fingers and thumb pressing against a writing instrument (e.g., the stylus 500) with a predictable or measurable pressure profile, including periods of relatively higher or lower pressure against the writing instrument with each finger or thumb. By obtaining pressure data from the pressure sensor matrix 518 during a writing operation with the stylus 500, an HMD system (e.g., the processing subsystem 110 of HMD system 100 in FIG. 1) may identify a pressure profile associated with the writing operation and may use the pressure profile (and potentially additional data from other sensors of the stylus 500 or of the HMD system) to predict and estimate an identity of a grapheme intended to be written by the user.

In some embodiments, the pressure sensor matrix 518 may extend closer to a tip of the stylus 500 than is depicted in FIG. 5, and/or further toward the back end portion 510. The pressure sensor matrix 518 may, in some examples, extend along a majority of a longitudinal length of the elongated housing 502.

The tip subsystem 504 of the stylus 500 may include a magnetic ball 524 and a magnetic field sensor 526 used to identify and detect rotation of the magnetic ball 524. In some examples, “magnetic ball” may refer to a ball or other roller that alters a surrounding magnetic field as it rotates. The magnetic ball 524 may be or include a ferromagnetic material, an electromagnet, a rare earth magnet, or another material that affects and/or responds to a magnetic field. As the magnetic ball 524 rotates, the magnetic field sensor 526 may detect a change in a magnetic field based on rotation of the magnetic ball 524. Data from the magnetic field sensor 526 may be used to estimate rotation of the magnetic ball 524 as the magnetic ball 524 interacts with a real-world object, such as by virtually writing on, virtually drawing on, or otherwise touching a surface of the real-world object. Data corresponding to rotation of the magnetic ball 524 may be used to generate an image for display in an HMD system, such as a line, a grapheme, or a drawing, etc.

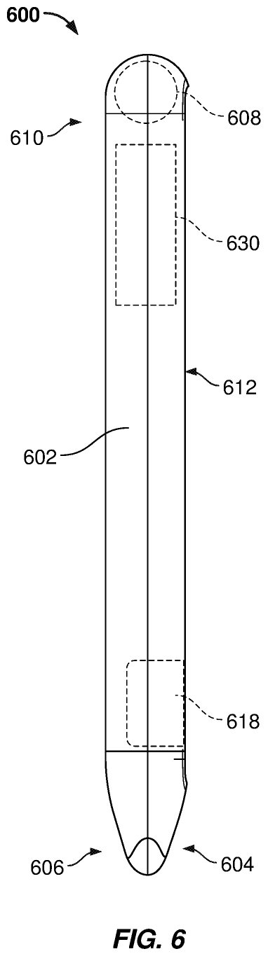

FIG. 6 illustrates a side view of another embodiment of a stylus 600. The stylus 600 may be similar to the styluses 400, 500 described above with reference to FIGS. 4 and 5, and may include other elements described herein that are not depicted in FIG. 6. The stylus 600 may include an elongated housing 602 dimensioned to be grasped by a user's hand, a tip subsystem 604 at a tip end portion 606, a tracking component 608 at, for example, a back end portion 610, a touch strip 612 along a portion of a length of the stylus 600, and a pressure sensor matrix 618 near the tip end portion 606 wrapped at least partially around a circumference of the elongated housing 602. Example tip subsystems, tracking components, touch strips, and pressure sensor matrices suitable for use with the stylus 600 are described above.

The stylus 600 may also include a power supply system 630 to provide electrical power to the various sensors and other electrical components of the stylus 600. The power supply system 630 may include a power storage element (e.g., a battery and/or a capacitor, etc.). In some embodiments, the power supply system 630 also includes a recharging module for supplying electrical energy to the power storage element. The recharging module, if present, may be configured for wired or wireless charging, and may be internal to the stylus 600 and/or may be external to the stylus 600 (e.g., a charging station, an AC adapter, a charging pad, etc.). Alternatively, the power storage element may be removable and replaceable.

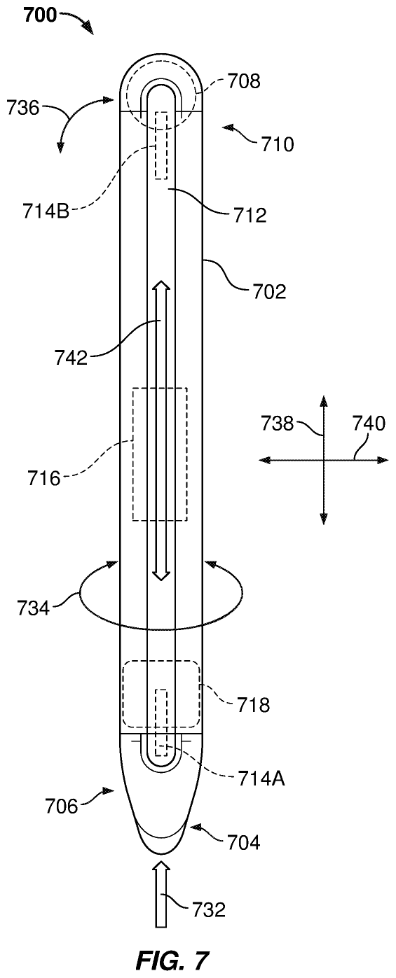

FIG. 7 is a side view of a stylus 700 according to some embodiments of the present disclosure, and illustrates various manipulations that the stylus 700 or an associated HMD system may be configured to detect and track. The manipulations can be performed by a user of the stylus 700 to execute various actions and gestures in a VR/AR/MR environment, for example.

Similar to other embodiments described in the present disclosure, the stylus 700 may include an elongated housing 702, a tip subsystem 704 at a tip end portion 706, a tracking component 708 at a back end portion 710, a touch strip 712 along a portion of a length of the stylus 700, a first mechanical button 714A positioned under the touch strip 712 at or near the tip end portion 706, a second mechanical button 714B positioned under the touch strip 712 at or near the back end portion 710, at least one motion sensor 716 disposed within the elongated housing 702, and a pressure sensor matrix 718 positioned at least partially around a circumference of the elongated housing 702 and at or near the tip end portion 706.

The elements of the stylus 700 shown in FIG. 7 may be used to detect different manipulations of the stylus 700. By way of example and not limitation, a tip pressure 732 exerted on the tip end portion 706 of the stylus 700 may be detected by the tip subsystem 704. In some embodiments, the tip subsystem may measure a magnitude and/or direction of the tip pressure 732. In addition, the tip subsystem 704 may be configured to detect a translation (e.g., rolling, dragging, etc.) action of the tip end portion 706 in open space or against a real-world surface (e.g., a passive surface).

A user may manipulate the stylus 700 by pressing the mechanical buttons 714A, 714B. Depending on the application, the mechanical buttons 714A, 714B may be used for many different actions in a VR/AR/MR environment or in the real-world environment. By way of example, a user may press the mechanical buttons 714A, 714B to select or switch modes of the stylus 700 or an associated HMD system, such as a surface mode, a non-surface mode, an “on” start, an “off” state, a low-power state, a pass-through mode, a video capture mode, an image capture mode, etc. In another example, the mechanical buttons 714A, 714B may be used to make a selection or perform an action in a VR/AR/MR environment, such as to interact with a virtual object, to begin a writing or drawing operation, to erase or delete a virtual object, to display a virtual image (e.g., a menu, object, selection tool, etc.), to enlarge or shrink a virtual object, to activate a virtual mechanism, to make a selection of a virtual or real-world object, etc.

The motion sensor(s) 716 may be configured to detect axial rotation 734 (i.e., rotation about a longitudinal axis). A user may axially rotate the stylus 700 for a variety of reasons depending on a particular application, such as to manipulate a virtual object. The motion sensor(s) 716 may also be configured to detect tilting 736 (i.e., rotation about an axis orthogonal to the longitudinal axis), axial translation 738, and lateral translation 740 of the stylus 700. The motion sensor(s) 716 may, in some embodiments, be configured to detect both a distance and speed of motion, in linear and/or angular terms. Data associated with the detected motion may be used for many different actions in a VR/AR/MR environment or in the real-world environment, such as the actions described above or others. The data from the motion sensor(s) 716 may also be used to assist in tracking the stylus 700 in a real-world environment and/or in a VR/AR/MR environment, including to estimate a position and/or an orientation of the stylus 700 or to predict an estimated future position and/or orientation of the stylus 700.

The touch strip 712 may be configured to detect a user touching the touch strip 712. In some embodiments, a user may manipulate the stylus 700 with a dragging touch 742 on the touch strip 712. The dragging touch 742 may be a gesture that results in different actions, depending on a particular application. By way of example and not limitation, a dragging touch 742 on the touch strip 712 may result in scrolling through virtual objects or options displayed on an associated HMD device, swiping across a virtual object, moving a virtual object, enlarging or shrinking a virtual object, adjusting a brightness of a virtual image or portion thereof, changing a sensitivity of a control operation, etc.

The pressure sensor matrix 718 may be configured to detect a pressure exerted on a side of the elongated housing 702, such as by a hand or fingers of a user. The pressure sensor matrix 718 may, in some embodiments, detect both a presence and a magnitude of pressure in one or multiple locations on the pressure sensor matrix 718. Exerting pressure on the pressure sensor matrix 718 may provide various indications to an associated HMD system, such as readiness for a writing or drawing operation, activation of a virtual mechanism, selection of a virtual or real-world object, manipulation of a virtual object, etc. In addition, data from the pressure sensor matrix 718 may be used by an associated HMD system to generate a pressure profile for an action or intended action, such as a user writing a grapheme.

In addition, the tracking component 708 may be used by an associated HMD system to detect manipulations of the stylus 700, including the axial rotation 734, tilting 736, axial translation 738, lateral translation 740, etc. Data from detection of the tracking component 708 in a real-world environment, such as by at least one image sensor of an associated HMD system or HMD device, may be used alone or in combination with data from the various components and sensors of the stylus 700 to track the stylus 700 in the real-world environment and in a VR/AR/MR environment.

Data representative of the various manipulations of the stylus 700 may be communicated from the various components and sensors of the stylus 700 to an associated HMD system for processing and for use (e.g., to generate a displayed image, to perform an action, to select a virtual or real-world object, etc.) in an associated HMD device.

In one example, a stylus 800 may be manipulated by a user to form a grapheme 850 in a VR/AR/MR environment, as illustrated in FIG. 8. Like some of the embodiments described above, the stylus 800 of FIG. 8 may include, among other components and sensors, an elongated housing 802, a tip subsystem 804 at a tip end portion 806, a tracking component 808 at a back end portion 810, a touch strip 812 along a portion of the elongated housing 802, a mechanical button 814 at or near the tip end portion 806 (e.g., under a portion of the touch strip 812), at least one motion sensor 816, and a pressure sensor matrix 818.

The grapheme 850 shown in FIG. 8 is, by way of explanatory example, an English capital letter “A.” However, similar concepts as those described with reference to the letter “A” of FIG. 8 may be used to track manipulation of the stylus 800 for forming other graphemes, drawings, or other objects in a VR/AR/MR environment.

To form the grapheme 850, the user may manipulate the stylus 800 to perform a first motion 852 upward and to the right with the tip end portion 806 of the stylus 800, then a second motion 854 downward and to the left. A third motion 856 upward and to the left may be made by the user to position the tip end portion 806 for further writing or drawing, but not with the intent to write or draw during the third motion 856. A fourth motion 858 to the right may complete the grapheme 850.

The stylus 800 and an associated HMD system may use sensor data from the stylus 800 to identify the intended grapheme 850. The user may initially indicate whether the stylus is to be used in a surface mode in which the tip end portion 806 is pressed against a surface (e.g., a passive surface) of a real-world object, or in a non-surface mode in which the stylus 800 is to be manipulated in an open space while forming the grapheme 850.

If the surface mode is indicated by the user, then pressure exerted on the stylus 800 against the surface may be sensed by the tip subsystem 804, such as during the first, second, and fourth movements 852, 854, and 858. The lack of pressure exerted against the tip subsystem 804 during the third movement 856 may indicate that a writing or drawing segment is not intended. In addition, in embodiments where the tip subsystem 804 employs a roller or other device for tracking interaction with a surface, rolling or dragging the tip end portion 806 across a surface may provide additional data for indicating an intended writing or drawing operation.

In a non-surface mode, the user may manipulate the stylus 800 to indicate that a writing or drawing segment is or is not intended. For example, the user may press against a mechanical button 814 during an intended writing or drawing segment (e.g., during the first, second, and fourth movements 852, 854, and 858 in the example of FIG. 8) and may release the mechanical button 814 during a movement when no writing or drawing is intended (e.g., during the third movement 856). Alternatively or additionally, the user may exert pressure against the pressure sensor matrix 818 during the intended writing or drawing segments, but may reduce the exerted pressure when no writing or drawing is intended. Alternatively, the user may not make any indication between the segments where writing or drawing is intended and the segments where no writing or drawing is intended, and the HMD system may predict the intended grapheme 850 from data representative of all of the movements 852, 854, 856, and 858.

In addition, the pressure sensor matrix 818 may obtain data to create a pressure profile representative of a capital letter “A” of FIG. 8, or of another grapheme 850. Using the capital letter “A” grapheme 850 of FIG. 8 as an example, during the first movement 852, the user may initially exert a relatively high pressure against the pressure sensor matrix 818 that decreases throughout the first movement 852. During the second movement 854, the exerted pressure may initially be low, and may increase to the end of the second movement 854. The third movement 856 may include an initially high pressure that is reduced until the end of the third movement 856. The fourth movement 858 may be characterized by a relatively constant pressure on the pressure sensor matrix 818. Thus, the data obtained by the pressure sensor matrix 818 may be used to create a pressure profile for each intended grapheme 850. The pressure profile may, in some embodiments, be user-specific. For example, the user may be prompted to write, with the stylus 800, a series of known graphemes 850, and the HMD system may record respective pressure profiles for the graphemes 850 for the user. In other embodiments, predetermined average pressure profiles may be used, either initially or persistently. In some embodiments, the HMD system may employ machine learning to improve prediction of intended graphemes 850, such as by adjusting the pressure profiles or average pressure profiles during a series of writing operations, including in response to corrections made when the user indicates an error in the HMD system's interpretation of the pressure profiles.

Data obtained by the motion sensor(s) 816 during a writing or drawing operation may also be used by the stylus 800 or the associated HMD system to form the grapheme 850 in a VR/AR/MR environment. For example, data representative of axial rotation, tilting, axial translation, and lateral translation of the stylus 800 may be used in both of a surface mode and a non-surface mode to track movement of the tip end portion 806 to determine (e.g., predict, estimate, track) an intended grapheme 850. Similarly, the tracking component 808 may be used by the HMD system to track movement of the stylus 800, alone or in conjunction with the data from the motion sensor(s) 816, to determine or estimate an intended grapheme.

Data from any combination of the sensors (e.g., the tip subsystem 804, the touch strip 812, the mechanical button 814, the motion sensor 816, the pressure sensor matrix 818, etc.) in the stylus 800 and from tracking of the tracking component 808 by the associated HMD system may be used to determine a grapheme 850 or drawing intended by the user to be formed in the VR/AR/MR environment. In some embodiments, data from the respective sensors and tracking component 808 may provide redundant ways for the HMD system to determine the intended grapheme 850 or drawing, such as for improved accuracy and precision. By way of example, pressure profiles generated for two different graphemes may be similar and therefore ambiguous, but data obtained from the motion sensor(s) 816, tip subsystem 804, tracking component 808, and/or mechanical button 814 may be used to distinguish between the two different graphemes. Moreover, text recognition technology may be employed to identify the intended grapheme 850 based on data representative of manipulation of the stylus 800.

Referring to FIG. 9, an HMD system 900, including a stylus 902 and an HMD device 904, is illustrated during use by a user 906. The HMD device 904, which may be a VR, AR, or MR device, may be positioned over the eyes of the user 906, and the stylus 902 may be held in a hand of the user 906. As described above with reference to FIG. 1, a processing subsystem may be in communication (e.g., wired or wireless communication) with both the stylus 902 and the HMD device 904. Such a processing subsystem may be remote from the HMD device 904 and from the stylus 902 and/or formed as an integral part of the HMD device 904 or an integral part of the stylus 902.

The HMD device 904 may display a virtual image 910 for viewing by the user 906. The virtual image 910 may appear to the user 906 to be some distance in front of the user 906, such as near arm's length, as illustrated in FIG. 9. The user 906 may manipulate the stylus 902 to interact with the virtual image 910. Manipulation of the stylus 902 may also be referred to as performing a gesture with the stylus 902. By way of example, the user 906 may move (e.g., laterally translate, axially translate, tilt, rotate, etc.) the stylus 902 or physically interact with sensors (e.g., a touch strip, a mechanical button, a pressure sensor matrix, etc.) of the stylus 902 to perform different actions in the VR/AR/MR environment. For example, the manipulations may be performed by the user 906 to select a virtual or real-world object, make a selection from a virtual list or menu, grab a virtual object, move a virtual object laterally or apparently closer or farther away, enlarge or shrink a virtual object, rotate or tilt a virtual object, activate a virtual object or mechanism, delete a virtual object, create a virtual object, play virtual content (e.g., a video or sequence of images), display a view of the real-world environment or a portion thereof, capture an image of a virtual or real-world object or scene, etc. In one example, the user 906 may manipulate the stylus 902 to write a grapheme or series of graphemes in the VR/AR/MR environment, such as described above with reference to FIG. 8. The user 906 may also manipulate the stylus 902 to adjust the virtual image 910, such as to adjust the size, apparent distance, or brightness of the virtual image 910 or a portion thereof. Various example manipulations of the stylus 902 are described in this disclosure to accomplish these and other tasks in the VR/AR/MR environment. In some embodiments, haptic feedback may be provided to the user 906, such as by vibrating the stylus 902 when a selection is made or another action is taken in the VR/AR/MR environment.

As discussed above, in some examples the user 906 may interact with the stylus 902 to directly create or manipulate virtual objects or selections in an VR/AR/MR environment. In other examples, the user 906 may interact with the stylus 902 to indirectly manipulate a virtual or real object. For example, the user 906 may use the stylus 902 to remotely control or manipulate a remote robot, such as a telepresence robot that is physically separated from the user 906 and configured to receive and execute commands via a network. Specifically, the user 906 may, by manipulating the stylus 902, cause the remote robot to perform an action, such as moving, physically or virtually drawing or writing a design or grapheme, grasping a real or virtual object, etc.

FIG. 10 is a flow diagram showing a method 1000 of assembling a stylus, according to some embodiments of this disclosure. As indicated at operation 1010, at least one sensor may be coupled to an elongated housing. Example sensors for coupling to an elongated housing are described in this disclosure, including motion sensors, pressure sensors, pressure sensor matrices, tip subsystems, magnetic field sensors, touch strips, mechanical buttons, proximity sensors, rollers, etc. Depending on the sensor type and function, the sensors may be coupled within the elongated housing, on an exterior of the elongated housing, or both within and on an exterior of the elongated housing. A tracking component may also be coupled to the elongated housing, as indicated at operation 1020. Example tracking components are described in this disclosure, and include, for example, a light source (e.g., IR LED(s)), a light-reflective element, a magnetic field generator or sensor, or a physical feature with a known shape and orientation. Operations 1010 and 1020 may be performed in any order.

FIG. 11 shows a flow diagram of a method 1100 of operating an HMD system, according to some embodiments of this disclosure. In operation 1110, manipulation of a stylus by a user may be sensed, such as by at least one sensor on the stylus. For example, the user may move (e.g., axially translate, laterally translate, tilt, and/or rotate) the stylus in space, touch a touch strip, press a mechanical button, press a tip of the stylus against a surface (e.g., a passive surface) of a real-world object, move the tip of the stylus across a surface of a real-world object, shake the stylus, squeeze the stylus, etc. The manipulation of the stylus may be sensed by at least one sensor on the stylus, by a component (e.g., an image sensor, a magnetic field sensor, etc.) of the HMD system, or a combination thereof.

In operation 1120, an image of a tracking component of the stylus may be captured, such as by one or more image sensors of an HMD device. Position information, including location and orientation, in the real-world environment and in a VR/AR/MR environment, may be recorded by the image sensor(s). Operations 1110 and 1120 may be performed in any order or simultaneously.

In operation 1130, the stylus may be tracked in a VR/AR/MR environment based on at least one of the sensed manipulation of operation 1110 and the image of the tracking component captured in operation 1120. For example, a processing subsystem of the HMD system may receive and use data representative of the manipulation of the stylus and of the captured image to identify the tracking component of the stylus within the image, and to determine a position (e.g., location and orientation) of the stylus in the real-world environment. Actions may be performed in the VR/AR/MR environment based on the manipulation of the stylus, such as rendering and displaying an image or altering an image displayed to the user by the HMD device.

Accordingly, disclosed are styluses and related HMD systems and methods that may, in some examples, improve usability of styluses in a VR/AR/MR environment. Accurate and precise detection of manipulation of styluses in the VR/AR/MR environment may be enabled by sensors and/or components of the styluses, such as motion sensors, tip subsystems, pressure sensors, tracking components, mechanical buttons, and other sensors and components described herein. The styluses may be used in a surface mode while interacting with a physical surface in a real-world environment or in a non-surface mode while being manipulated in an open space. In some examples, the formation of graphemes in a VR/AR/MR environment may be facilitated by the sensor(s) and components of the styluses.

As detailed above, the computing devices and systems described and/or illustrated herein broadly represent any type or form of computing device or system capable of executing computer-readable instructions, such as those contained within the modules and subsystems described herein. In a basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), Flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules and subsystems described and/or illustrated herein may represent portions of a single module or application. In addition, in certain embodiments one or more of these modules and subsystems may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules or subsystems described herein may transform data, physical devices, and/or representations of physical devices from one form to another. For example, one or more of the modules recited herein may receive sensor data to be transformed, transform the sensor data, output a result of the transformation to alter a displayed image, use the result of the transformation to determine a position of a stylus in a real-world environment, and store the result of the transformation to perform actions in a VR/AR/MR environment. Additionally or alternatively, one or more of the modules and subsystems recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and Flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A stylus, comprising:
an elongated housing that is dimensioned to be grasped by a user's hand;
at least one sensor that is configured to detect manipulation of the stylus by the user; and
a tracking component that enables the stylus to be tracked in a virtual, augmented, or mixed reality (“VR/AR/MR”) environment by an image sensor positioned on a head-mounted display.

2. The stylus of claim 1, further comprising a communication component configured to transmit sensor data generated by the sensor to the head-mounted display system.

3. The stylus of claim 1, wherein the manipulation of the stylus comprises movement of the stylus in a shape resembling a grapheme.

4. The stylus of claim 3, wherein:
the manipulation of the stylus further comprises a pressure exerted on the stylus; and
the sensor comprises a pressure sensor that is configured to:
detect the pressure exerted on the stylus; and
generate sensor data based on the pressure exerted on the stylus.

5. The stylus of claim 1, wherein the sensor comprises pressure sensors that are disposed along the elongated housing and configured to detect pressure exerted by at least one finger of the user's hand.

6. The stylus of claim 1, wherein the sensor comprises at least one of:
a pressure-sensitive tip that is configured to detect pressure exerted on a tip of the stylus when the stylus interacts with a surface; or
a magnetic field sensor that is configured to detect rotation of a magnetic ball positioned at the tip of the stylus when the stylus interacts with a surface.

7. The stylus of claim 1, further comprising a haptic-feedback module that is configured to provide haptic feedback to the user in response to the manipulation.

8. The stylus of claim 1, wherein the stylus is configurable between:
a surface mode, in which the sensor detects the manipulation of the stylus as the stylus interacts with a passive surface; and
a non-surface mode, in which the sensor detects the manipulation of the stylus within space.

9. The stylus of claim 1, wherein the sensor comprises at least one inertial measurement unit (IMU) sensor that is disposed within the elongated housing and configured to generate sensor data relating to the manipulation of the stylus.

10. The stylus of claim 1, wherein the manipulation of the stylus comprises at least one of:
a press of at least one mechanical button;
a touch of at least a portion of the stylus;
a dragging touch across at least a portion of the stylus;
a tilting of the stylus;
a rotation of the stylus;
a press of a tip of the stylus against a surface of a real-world object;
a movement of the tip of the stylus across the surface of the real-world object;
a translation of the stylus in space; or
a squeezing of the stylus.

11. The stylus of claim 1, wherein the tracking component comprises at least one of:
an electrically active component; or
an electrically passive component.

12. A head-mounted display system, comprising:
a stylus, comprising:
an elongated housing that is dimensioned to be grasped by a user's hand; and
a tracking component disposed on or within the elongated housing; and
a head-mounted display device, comprising:
a tracking subsystem that is configured to track, using at least the tracking component, manipulation of the stylus in a real-world environment; and
a display subsystem configured to display, based on tracking information received from the tracking subsystem, an image based on the manipulation of the stylus within a virtual, augmented, or mixed reality (“VR/AR/MR”) environment.

13. The head-mounted display system of claim 12, wherein the tracking subsystem is configured to track the stylus by:
capturing images of the stylus in a real-world environment;
identifying, within the images, the tracking component of the stylus; and
tracking, based on a position of the tracking component within the images, the stylus within the real-world environment.

14. The head-mounted display system of claim 13, wherein:
the tracking component of the stylus comprises at least one infrared light-emitting diode disposed on or within the elongated housing; and
the tracking subsystem comprises an image sensor configured to capture the images of the stylus in the real-world environment.

15. The head-mounted display system of claim 12, wherein the stylus further comprises:
at least one sensor that is configured to detect the manipulation of the stylus; and
a communication component configured to transmit sensor data generated by the sensor to the tracking subsystem.

16. The head-mounted display system of claim 15, wherein the tracking subsystem is configured to at least one of:
identify the manipulation of the stylus based on the sensor data received from the communication component; or
track, using both the tracking component and the sensor data received from the communication component, the stylus within the VR/AR/MR environment.

17. The head-mounted display system of claim 12, wherein:
the manipulation of the stylus comprises movement of the stylus in a shape resembling a grapheme; and
the head-mounted display system further comprises a processing subsystem configured to identify, based on the movement of the stylus, the grapheme.

18. The head-mounted display system of claim 17, wherein:
the manipulation of the stylus further comprises a pressure exerted on the stylus;
the stylus comprises a pressure sensor that is configured to:
detect the pressure exerted on the stylus; and
generate sensor data based on the pressure exerted; and
the processing subsystem is configured to identify the grapheme by identifying, based on the sensor data, a pressure profile that is associated with the grapheme.

19. The head-mounted display system of claim 18, wherein the pressure exerted on the stylus comprises at least one of:
pressure exerted on a tip of the stylus when the stylus interacts with a surface; or
pressure exerted by at least one of the user's fingers on the elongated housing.

20. A method of assembling a stylus, comprising:
coupling at least one sensor to an elongated housing that is dimensioned to be grasped by a user's hand, the sensor being configured to detect manipulation of the stylus by the user; and
coupling a tracking component to the elongated housing, wherein the tracking component enables the stylus to be tracked in a virtual, augmented, or mixed reality (“VR/AR/MR”) environment by a tracking subsystem of a head-mounted display device.
